(19) United States
(12) Patent Application Publication
(10) Pub. No.: US 2009/0016719 A1
(43) Pub. Date: Jan. 15, 2009

(54) OPTICAL TRANSPONDER INTERFACING MULTIPROTOCOL SIGNAL AND METHOD OF INTERFACING MULTIPROTOCOL SIGNAL

(75) Inventors: Joon Ki Lee, Daejeon (KR); Jyung Chan Lee, Daejeon (KR); Kwangjoon Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeo (KR)

(21) Appl. No.: 12/171,586

(22) Filed: Jul. 11, 2008

(30) Foreign Application Priority Data
Jul. 13, 2007 (KR) 10-2007-0070798

(51) Int. Cl. H04J 11/00

(52) U.S. Cl. 398/58

(57) ABSTRACT

Provided are an optical transponder that interfaces a multiprotocol signal and a method of interfacing a multiprotocol signal. The optical transponder includes: an optical transceiver, which optical/electrical converts and multiplexes/demultiplexes an input signal; a reception clock generator, which generates a clock on a reception path; a transmission clock generator, which generates a clock on a transmission path; an optical transport hierarchy (OTH) framer, which processes an OTH signal when the input signal is the OTH signal; a synchronous digital hierarchy (SDH)/synchronous optical network (SONET) framer, which processes an SDH/SONET signal or a gigabit Ethernet (GbE) when the input signal is the SDH/SONET signal or the GbE signal; and a controller which controls the optical transceiver, the reception clock generator, the transmission clock generator, the OTH framer, and the SDH/SONET framer according to the type of the input signal. Accordingly, one optical transponder can receive various types of protocol signals, and thus different optical transponders are not separately required according to a type of a connected signal.

### CROSS-REFERENCE TO RELATED PATENT APPLICATION

This application claims the benefit of Korean Patent Application No. 10-2007-0070798, filed on Jul. 13, 2007, in the Korean Intellectual Property Office, the disclosure of which is incorporated herein in its entirety by reference.

### BACKGROUND OF THE INVENTION

1. Field of the Invention

The present invention relates to an optical transponder which receives a tributary signal, such as a synchronous digital hierarchy (SDH)/synchronous optical network (SONET) signal, a gigabit Ethernet (GbE) signal, a storage area network (SAN) signal, or the like, in a wavelength division multiplexing (WDM) transmission system or a SDH/SONET system, and more particularly, to an optical transponder which can receive various protocol signals, such as a SDH/SONET signal, an optical transport hierarchy (OTH) signal, and a GbE signal.

This work was supported by the IT R&D program of MIC/IITA. [2006-S-059-01, ASON based Metro Photonic Cross-Connect Technology]

2. Description of the Related Art

An optical transponder connects a WDM transmission system and an SDH/SONEAT system with an external client network. A convention optical transponder is developed to mainly receive an SDH/SONET signal, such as an STM-16/OC-48 signal or an STM-64/OC-192 signal. However, recently, as data communication traffic tremendously increases, requirement for interface of various tributary signals, such as a GbE signal, a fiber channel (FC) signal, and an enterprise systems connectivity (ESCON) signal, is increased, i.e. requirement for processing a multiprotocol signal is increased. Also, as the speed of an optical channel of the WDM transmission system increased from 2.5 Gb/s to 10 Gb/s, four STM-16/OC-48 signals are multiplexed or plural GbE signals are multiplexed to a 10 Gb/s optical transport network (OTN) (optical channel transport unit 2 (OTU2)) signal before being transmitted so as to improve efficiency of an optical channel application in the WDM transmission system. In order to fulfill such aim, the optical transponder is used. A currently commercialized optical transponder mainly receives GbE signals up to 8 channels, and multiplexes and transmits the GbE signals to an OTU2 signal.

FIG. 1 is a block diagram illustrating a conventional optical transponder 100. A 10 Gb/s SHD/SONET (STM-64/OC-192) optical signal is interfaced in FIG. 1. The STM-64/OC-192 optical signal is optical/electrical converted in an optical/electrical converter 112 of an optical transceiver 110, converted to sixteen 622 [Mb/s] signals in a multiplexer/demultiplexer 114, and then input to an SDH/SONET framer 120. The SDH/SONET framer 120 performs a signal process of an STM-64/OC-192 protocol, and thus the sixteen 622 [Mb/s] signals are converted to four 2.5 [Gb/s] signals and then outputted. In the case of an opposite path, the STM-64/OC-192 optical signal is outputted in an inverse process. Here, generally, a clock of 622 [MHz] is required in a transmission (TX) path process, and this clock is generated by a system clock generator 130 and is provided to the SDH/SONET framer 120 and the multiplexer/demultiplexer 114. A clock of 155.52 [MHz] is required in a reception (RX) path process, and this clock is generated by a crystal oscillator (XO) and is provided to the multiplexer/demultiplexer 114.

A past optical transmission network is based on an SDH/SONET hierarchical signal, but in a current optical transmission network, an OTH hierarchical based WDM or reconfigurable optical add drop (ROAD) system and an SDH/SONET hierarchical based SDH/SONET system are mutually complement each other. Also recently, data communication traffic tremendously increased, and thus receiving a gigabit Ethernet signal became necessary. As various signals are transmitted via an optical transmission network, optical transmission systems need to interface these various signals.

However, an optical transponder is required for each protocol signal, and so a manufacturer needs to separately manufacture an optical transponder that corresponds to each protocol signal. Also, a communication operator needs to manage various optical transponders.

### SUMMARY OF THE INVENTION

Since types of a signal transmitted from an optical transmission network are being diversified and a structure of the optical transmission network is being simplified, possibility of combining functions of various equipments is increased. Accordingly, if one optical transponder can receive various types of protocols, not only the structure of an apparatus can be simplified but also a system can be flexible according to requirements of a network. Also, expenses in terms of production control can be reduced. In this behalf, the present invention provides an optical transponder, which can interface all signals, such as an STM-64/OC-192 signal, an OTU2 signal, and 10 GbE signal, and a method of interfacing a signal by automatically reorganizing hardware by recognizing a type of a protocol signal.

According to an aspect of the present invention, there is provided an optical transponder that interfaces a multiprotocol signal, the optical transponder including: an optical transceiver, which optical/electrical converts and multiplexes/demultiplexes an input signal; a reception clock generator, which generates a clock on a reception path; a transmission clock generator, which generates a clock on a transmission path; an optical transport hierarchy (OTH) framer, which processes an OTH signal when the input signal is the OTH signal; a synchronous digital hierarchy (SDH)/synchronous optical network (SONET) framer, which processes an SDH/SONET signal or a gigabit Ethernet (GbE) when the input signal is the SDH/SONET signal or the GbE signal; and a controller which controls the optical transceiver, the reception clock generator, the transmission clock generator, the OTH framer, and the SDH/SONET framer according to the type of the input signal.

According to another aspect of the present invention, there is provided a method of interfacing a multiprotocol signal, the method including: detecting a type of an input signal; optical/electrical converting and multiplexing/demultiplexing the input signal; and processing an OTH signal, an SDH/SONET signal, or a GbE signal by generating a clock signal corresponding to the detected type.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a conventional optical transponder;

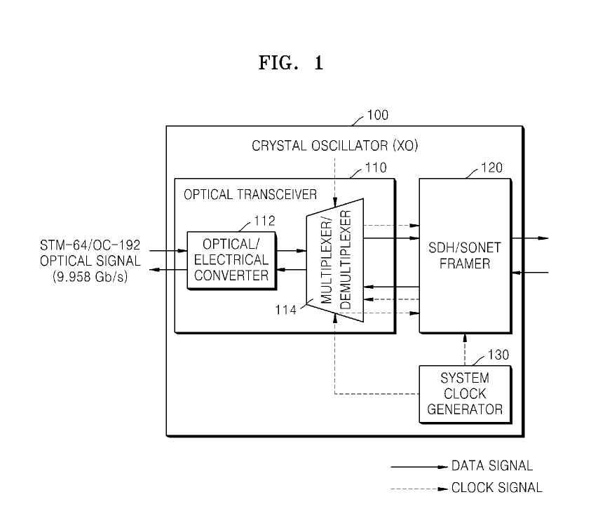

FIG. 2 is a block diagram for describing an optical transponder that interfaces a multiprotocol signal according to the present invention;

FIG. 3 is a block diagram for describing a reception clock generator illustrated in FIG. 2;

FIG. 4 is a block diagram for describing a transmission clock generator illustrated in FIG. 2;

FIG. 5 is a flowchart for describing a method of interfacing a multiprotocol signal according to the present invention;

FIG. 6 is a flowchart for describing operation 500 illustrated in FIG. 5; and

FIG. 7 is a flowchart for describing in detail a method of interfacing a multiprotocol signal according to an embodiment of the present invention.

### DETAILED DESCRIPTION OF THE INVENTION

The present invention will now be described more fully with reference to the accompanying drawings, in which exemplary embodiments of the invention are shown.

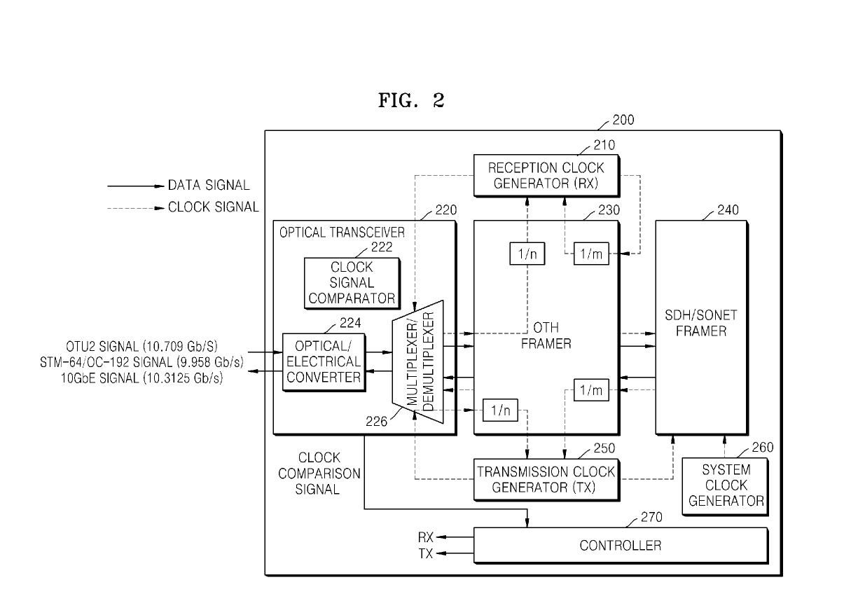

FIG. 2 is a block diagram for describing an optical transponder 200 that interfaces a multiprotocol signal according to the present invention. The optical transponder 200 includes a reception clock generator (RX) 210, an optical transceiver 220, an OTH framer 230, an SDH/SONET framer 240, a transmission clock generator (TX) 250, a system clock generator 260, and a controller 270.

The reception clock generator 210 generates a clock on a reception path.

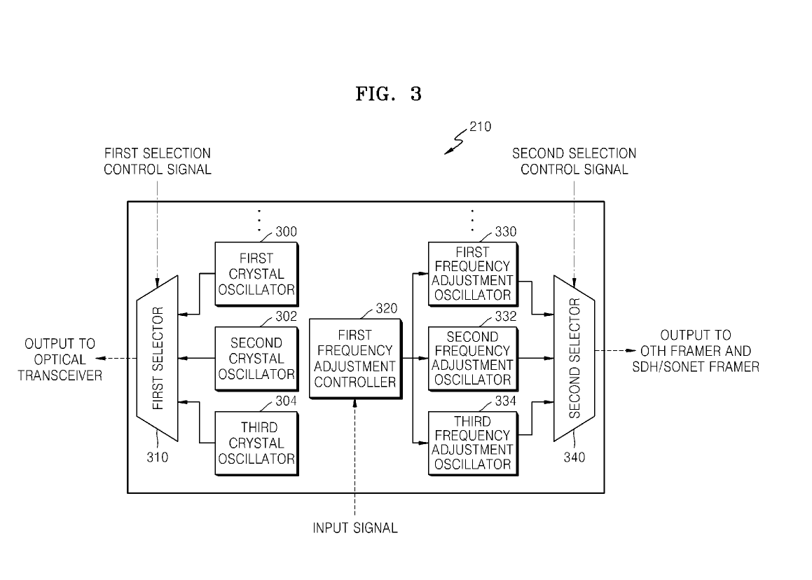

FIG. 3 is a block diagram for describing the reception clock generator 210 illustrated in FIG. 2. The reception clock generator 210 includes a first through K-th crystal oscillators 300, 302, and 304, a first selector 310, a first frequency adjustment controller 320, a first through K-th frequency adjustment oscillator 330, 332, and 334, and a second selector 340. Here, K is an integer and in the current embodiment, K is 3.

The first through third crystal oscillator 300, 302, and 304 output corresponding clock signals according to a type of an input signal. For example, the first crystal oscillator 300 oscillates a clock signal for identifying an SDH/SONET signal, the second crystal oscillator 302 oscillates a clock signal for identifying an OTH signal, and the third crystal oscillator 304 oscillates a clock signal for identifying a GbE signal.

The first selector 310 selects any one of the first through third crystal oscillator 300, 302, and 304 according to the control of the controller 270. According to a predetermined value, the controller 270 outputs a first selection control signal for clock oscillation of a certain crystal oscillator from among the first through third crystal oscillator 300, 302, and 304 to the first selector 310. The first selector 310 selects a crystal oscillator that corresponds to the first selection control signal provided from the controller 270 from among the first through third crystal oscillator 300, 302, and 304. A corresponding clock signal is outputted from the crystal oscillator selected by the first selector 310 to the optical transceiver 220.

The first frequency adjustment controller 320 outputs a signal for adjusting a frequency of a clock signal provided to the OTH framer 230 and the SDH/SONET framer 240 to the first through third frequency adjustment oscillator 330, 332, and 334 based on a clock signal reproduced by the input signal. The first frequency adjustment controller 320 uses a phase locking loop (PLL) circuit. The PLL circuit is used for phase detection and frequency oscillation, and is a conventional technology, and thus detailed descriptions thereof are omitted herein.

The first through third frequency adjustment oscillator 330, 332, and 334 outputs clock signals whose frequencies are adjusted according to the type of the input signal, according to the control of the first frequency adjustment controller 320. For example, the first frequency adjustment oscillator 330 oscillates a clock signal for receiving an SDH/SONET signal after adjusting its frequency, the second frequency adjustment oscillator 332 oscillates a clock signal for receiving an OTH signal after adjusting its frequency, and the third frequency adjustment oscillator 334 oscillates a clock signal for receiving a GbE signal after adjusting its frequency.

The second selector 340 selects a frequency adjustment oscillator for outputting a clock signal corresponding to the input signal from among the first through third frequency adjustment oscillator 330, 332, and 334, according to the control of the controller 270. The controller 270 outputs a second selection control signal for clock oscillation corresponding to the input signal from among the first through third frequency adjustment oscillator 330, 332, and 334 to the second selector 340. The second selector 340 selects a frequency adjustment oscillator corresponding to the second selection control signal provided by the controller 270 from among the first through third frequency adjustment oscillator 330, 332, and 334. The frequency adjustment oscillator selected by the second selector 340 outputs the corresponding clock signal to the OTH framer 230 and the SDH/SONET framer 240.

The optical transceiver 220 optical/electrical converts and multiplexes/demultiplexes the input signal. For this, the optical transceiver 220 includes a clock signal comparator 222, an optical/electrical converter 224, and a multiplexer/demultiplexer 226.

The clock signal comparator 222 compares whether the clock signal outputted from the crystal oscillator selected by the first selector 310 is identical to the clock signal reproduced by the input signal, and then outputs a clock comparison signal to the controller 270. When the clock signal reproduced by the input signal and the clock signal outputted from the selected crystal oscillator are identical, the type of the input signal corresponding to the outputted clock signal can be determined. The clock signal comparator 222 includes a conventional clock and data recovery (CDR) circuit. According to the CDR circuit, a desired frequency is generated by an external circuit, the generated desired frequency is compared to data, and then the data is restored by adjusting the phase so that the edge of the clock is in the middle of the data. In the present invention, the CDR circuit is used to compare the clock signal corresponding to the input signal and the clock signal oscillated by the crystal oscillator selected by the first selector 310.

The optical/electrical converter 224 optical/electrical converts the input signal, and outputs the result of conversion to the multiplexer/demultiplexer 226. When the input signal is a 9.958 [Gbps] STM-64/OC-192 optical signal, a 10.709 [Gbps] OTU2 optical signal, or a 10.3125 [Gbps] 10 GbE optical signal, the input signal is converted to an electric signal. Also, the optical/electrical converter 224 converts an electric signal to a corresponding optical signal.

The multiplexer/demultiplexer 226 outputs a 9.958 [Gbps] serial electric signal as a 16*622 [Mbps] parallel electric signal, a 10.709 [Gbps] serial electric signal as a 16*669 [Mbps] parallel electric signal, and a 10.3125 [Gbps] serial electric signal as a 16*644 [Mbps] parallel electric signal. Also, the multiplexer/demultiplexer 226 receives and outputs a 16*622 [Mbps] parallel electric signal as a 9.958 [Gbps] serial electric signal, a 16*669 [Mbps] parallel electric signal as a 10.709 [Gbps] serial electric signal, and a 16*644 [Mbps] parallel electric signal as a 10.3125 [Gbps] serial electric signal. The multiplexed electric signal is outputted to the OTH framer 230 and the SDH/SONET framer 240, and the demultiplexed electric signal is outputted to the optical/electrical converter 224.

The optical transceiver 220 may use any one of an MSA transceiver, an XFP transceiver, and an SERDES transceiver.

The controller 270 determines operation modes of the OTH framer 230 and the SDH/SONET framer 240 according to the clock comparison signal of the clock signal comparator 222. For example, when the reception clock generator 210 oscillates a clock signal corresponding to an OTH signal and the clock signal reproduced by the input signal and the oscillated clock signal are determined to be identical by the clock signal comparator 222, the input signal is determined to be the OTH signal. In other words, when it is determined that the input signal is the OTH signal based on the clock comparison signal of the clock signal comparator 222, the controller 270 adjusts the operation mode of the OTH framer 230 to process the OTH signal. In order for the controller 270 to enable the operation of the OTH framer 230, the controller 270 outputs the second selection control signal for clock oscillation for processing the OTH signal from among the first through third frequency adjustment oscillator 330, 332, and 334 to the second selector 340. According to the second selection control signal, the second selector 340 selects a frequency adjustment oscillator for the clock oscillation for processing the OTH signal. Then, the selected frequency adjustment oscillator outputs a clock signal for processing the OTH signal to the OTH framer 230.

Meanwhile, when the reception clock generator 210 oscillates a clock signal corresponding to an SDH/SONET signal and the clock signal comparator 222 determines that the clock signal reproduced by the input signal and the oscillated clock signal are identical, it is determined that the input signal is the SDH/SONET signal. In other words, when it is determined that the input signal is the SDH/SONET signal based on the clock comparison signal of the clock signal comparator 222, the controller 270 adjusts the operation mode of the SDH/SONET framer 240 to process the inputted SDH/SONET signal. The controller 270 outputs the second selection control signal for clock oscillation for processing an SDH/SONET signal from among the first through third frequency adjustment oscillator 330, 332, and 334 to the second selector 340. The second selector 340 selects a frequency adjustment oscillator that performs clock oscillation for processing the SDH/SONET signal according to the second selection control signal. The selected frequency adjustment oscillator outputs a clock signal for processing the SDH/SONET signal to the SDH/SONET framer 240.

Also, when the reception clock generator 210 oscillates a clock signal corresponding to a GbE signal and the clock signal comparator 222 determines that the clock signal reproduced by the input signal is identical to the oscillated clock signal, it is determined that the input signal is a GbE signal. In other words, when it is determined that the input signal is the GbE signal based on the clock comparison signal, the controller 270 adjusts the operation mode of the SDH/SONET framer 240 to process the inputted GbE signal. The controller 270 outputs the second selection control signal for clock oscillation for processing an 10 GbE signal from among the first through third frequency adjustment oscillator 330, 332, and 334 to the second selector 340. The second selector 340 selects a frequency adjustment oscillator that performs clock oscillation for processing the GbE signal according to the second selection control signal. The selected frequency adjustment oscillator outputs a clock signal for processing the GbE signal to the SDH/SONET framer 240.

Here, when it is determined that the input signal is the SDH/SONET signal or the GbE signal based on the clock comparison signal of the clock signal comparator 222, the controller 270 adjusts the OTH framer 230 to be bypassed. As the operation of the OTH framer 230 is bypassed, the SDH/SONET signal or the GbE signal provided from the optical transceiver 220 is transmitted to the SDH/SONET framer 240 via the OTH framer 230.

If an electric signal inputted via the optical transceiver 220 is the OTH signal, the OTH framer 230 processes the OTH signal. When the frequency adjustment oscillator selected by the second selector 340 outputs a clock signal for processing the OTH signal, such as a 699 [MHz] clock signal, to the OTH framer 230, the OTH framer 230 processes frames of an inputted 16*699.33 [MHz] parallel electric signal according to the 699 [MHz] clock signal.

If the input signal is the SDH/SONET signal or the GbE signal, the SDH/SONET framer 240 processes the SDH/SONET signal or the GbE signal. When the frequency adjustment oscillator selected by the second selector 340 outputs a clock signal for processing an STM-64/OC-192 signal, such as a 622 [MHz] clock signal, to the SDH/SONET framer 240, the SDH/SONET framer 240 processes frames of an inputted 16*622 [MHz] parallel electric signal according to the 622 [MHz] clock signal. Also, when the frequency adjustment oscillator selected by the second selector 340 outputs a clock signal for processing a 10 GbE signal, such as a 644 [MHz] clock signal, to the SDH/SONET framer 240, the SDH/SONET framer 240 processes frames of an inputted 16*644 [MHz] parallel electric signal according to the 644 [MHz] clock signal. Here, when the input signal is the 10 GbE signal, the SDH/SONET framer 240 maps the 10 GbE signal to the STM-64/OC-192. A mapping method is a conventional technology, and thus detailed descriptions thereof are omitted herein.

The transmission clock generator 250 generates a clock on a transmission path.

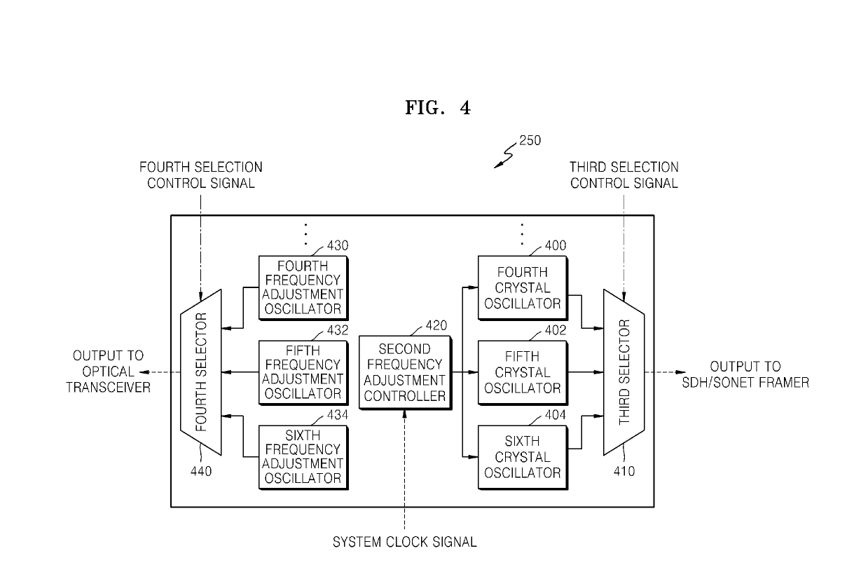

FIG. 4 is a block diagram for describing the transmission clock generator 250 illustrated in FIG. 2. The transmission clock generator 250 includes fourth through sixth crystal oscillators 400, 402, and 404, a third selector 410, a second frequency adjustment controller 420, fourth through sixth frequency adjustment oscillators 430, 432, and 434, and a fourth selector 440.

The fourth through sixth crystal oscillators 400, 402, and 404 output corresponding clock signals according to the type of the input signal. For example, the fourth crystal oscillator 400 oscillates a clock signal corresponding to the SDH/SONET signal, the fifth crystal oscillator 402 oscillates a clock signal corresponding to the OTH signal, and the sixth crystal oscillator 404 oscillates a clock signal corresponding to the GbE signal.

The third selector 410 selects any one of the fourth through sixth crystal oscillators 400, 402, and 404 according to the control of the controller 270. According to the type of the input signal identified during the reception process, the controller 270 outputs a third selection control signal for certain clock oscillation from among the fourth through sixth crystal oscillators 400, 402, and 404 to the third selector 410. The third selector 410 selects a crystal oscillator corresponding to the third selection control signal provided by the controller 270 from among the fourth through sixth crystal oscillators 400, 402, and 404. The selected crystal oscillator outputs a corresponding clock signal to the SDH/SONET framer 340.

The second frequency adjustment controller 420 outputs a signal for adjusting a frequency of a clock signal provided to the OTH framer 230 and the optical transceiver 220 based on a system clock generated by the system clock generator 260 to the fourth through sixth frequency adjustment oscillators 430, 432, and 434. The second frequency adjustment controller 420 uses a PLL circuit.

The fourth through sixth frequency adjustment oscillators 430, 432, and 434 outputs the clock signals whose frequencies are adjusted according to the type of the input signal, according to the control of the second frequency adjustment controller 420. For example, the fourth frequency adjustment oscillator 430 oscillates a clock signal for transmitting the SDH/SONET signal after adjusting its frequency, the fifth frequency adjustment oscillator 432 oscillates a clock signal for transmitting the OTH signal after adjusting its frequency, and the sixth frequency adjustment oscillator 434 oscillates a clock signal for transmitting the GbE signal after adjusting its frequency.

The fourth selector 440 selects a frequency adjustment oscillator for outputting a clock signal corresponding to the input signal from among the fourth through sixth frequency adjustment oscillators 430, 432, and 434 according to the control of the controller 270. The controller 270 outputs a fourth selection control signal for clock oscillation corresponding to the input signal from among the fourth through sixth frequency adjustment oscillators 430, 432, and 434 to the fourth selector 440. The fourth selector 440 selects a frequency adjustment oscillator corresponding to the fourth selection control signal provided to the controller 270 from among the fourth through sixth frequency adjustment oscillators 430, 432, and 434. The frequency adjustment oscillator selected by the fourth selector 440 outputs a corresponding clock signal to the optical transceiver 220.

The system clock generator 260 generates a system clock for operating a system. The system clock generated by the system clock generator 260 is provided to the second frequency adjustment controller 420, and the second frequency adjustment controller 420 outputs a signal for adjusting a frequency of a clock signal provided to the OTH framer 230 and the optical transceiver 220 based on the system clock. The system clock generator 260 is well known in the related art, and thus detailed descriptions thereof are omitted herein.

Meanwhile, the optical transponder according to the current embodiment interfaces any one multiprotocol signal from among a 10 [Gb/s] multiprotocol signal, a 2.5 [Gb/s] multiprotocol signal, and a 40 [Gb/s] multiprotocol signal.

Hereinafter, a method of interfacing a multiprotocol signal will be described with reference to attached drawings.

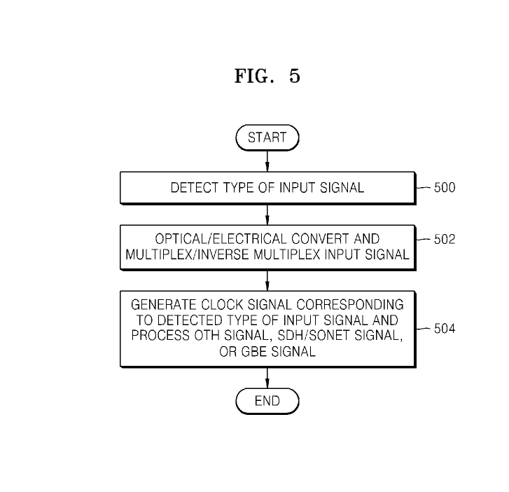

FIG. 5 is a flowchart for describing a method of interfacing a multiprotocol signal according to the present invention.

First in operation 500, a type of an input signal is detected.

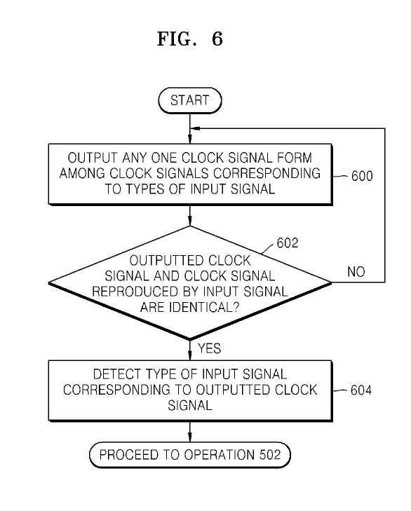

FIG. 6 is a flowchart for describing operation 500 illustrated in FIG. 5.

In operation 600, any one clock signal from among corresponding clock signals according to each type of the input signal is outputted. For example, referring to FIG. 3, the first crystal oscillator 300 oscillates a clock signal for identifying an SDH/SONET signal, the second crystal oscillator 302 oscillates a clock signal for identifying an OTH signal, and the third crystal oscillator 304 oscillates a clock signal for identifying a GbE signal.

Then, in operation 602, it is determined whether the outputted clock signal and a clock signal reproduced by the input signal are identical. If the outputted clock signal and the clock signal reproduced by the input signal are not identical, operations 600 and 602 are repeated.

However, if the outputted clock signal and the clock signal reproduced by the input signal are identical, the type of the input signal corresponding to the outputted clock signal is detected in operation 604. When the clock signal reproduced by the input signal and a clock signal outputted from a selected crystal oscillator are identical, the type of the input signal corresponding to the clock signal outputted form the selected crystal oscillator can be identified. For example, if a clock signal corresponding to the SDH/SONET signal is oscillated from the reception clock generator 210, and the clock signal comparator 222 determines that the clock signal reproduced by the input signal and the oscillated clock signal are identical, it is determined that the input signal is the SDH/SONET signal. Also, if a clock signal corresponding to the OTH signal is oscillated from the reception clock generator 210, and the clock signal comparator 222 determines that the clock signal reproduced by the input signal and the oscillated clock signal are identical, it is determined that the input signal is the OTH signal. In addition, if a clock signal corresponding to the GbE signal is oscillated from the reception clock generator 210, and the clock signal comparator 222 determines that the clock signal reproduced by the input signal and the oscillated clock signal are identical, it is determined that the input signal is the GbE signal.

Referring back to FIG. 5, after operation 500, the input signal is optical/electrical converted and multiplexed/demultiplexed in operation 502. If the input signal is a 9.958 [Gbps] STM-64/OC-192 optical signal, a 10.709 [Gbps] OTU2 optical signal, or a 10.3125 [Gbps] 10 GbE optical signal, the input signal is converted to an electric signal. A 9.958 [Gbps] serial electric signal is outputted as a 16*622 [Mbps] parallel electric signal, a 10.709 [Gbps] serial electric signal is outputted as a 16*669 [Mbps] parallel electric signal, and a 10.3125 [Gbps] serial electric signal is outputted as a 16*644 [Mbps] parallel electric signal. Also, a 9.958 [Gbps] serial electric signal is outputted when a 16*622 [Mbps] parallel electric signal is received, a 10.709 [Gbps] serial electric signal is outputted when a 16*669 [Mbps] parallel electric signal is received, and a 10.3125 [Gbps] serial electric signal is outputted when a 16*644 [Mbps] parallel electric signal is received. Each serial electric signal is converted to a corresponding optical signal.

After operation 502, a clock signal corresponding to the detected type is generated so as to process the OTH signal, the SDH/SONET signal, or the GbE signal in operation 504. When it is determined that the input signal is the OTH signal based on the clock comparison signal of the clock signal comparator 222, a clock signal for processing the OTH signal is oscillated. For example, when a 699 [MHz] clock signal for processing an OTU2 signal is outputted to the OTH framer 230, the OTH framer 230 processes frames of the inputted 16*699.33 [MHz] parallel electric signal according to the 699 [MHz] clock signal.

Meanwhile, if it is determined that the input signal is the SDH/SONET signal based on the clock comparison signal of the clock signal comparator 222, a clock signal for processing the SDH/SONET signal is oscillated. For example, when a 622 [MHz] clock signal for processing an STM-64/OC-192 signal is outputted to the SDH/SONET framer 240, the SDH/SONET framer 240 processes frames of an inputted 16*622 [MHz] parallel electric signal according to the 622 [MHz] clock signal. Also, if it is determined that the input signal is the GbE signal based on the clock comparison signal of the clock signal comparator 222, a clock signal for processing the GbE signal is oscillated. For example, when a 644 [MHz] clock signal for processing an 10 GbE signal is outputted to the SDH/SONET framer 240, the SDH/SONET framer 240 processes frames of an inputted 16*644 [MHz] parallel electric signal according to the 644 [MHz] clock signal. Here, if the input signal is the 10 GbE signal, the SDH/SONET framer 240 maps the 10 GbE signal to the STM-64/OC-192 signal. When it is determined that the input signal is the SDH/SONET signal or the GbE signal based on the clock comparison signal of the clock signal comparator 222, the OTH framer 230 is bypassed. As the OTH framer 230 is bypassed, the SDH/SONET signal or the GbE signal provided from the optical transceiver 220 is transmitted to the SDH/SONET framer 240 through the OTH framer 230.

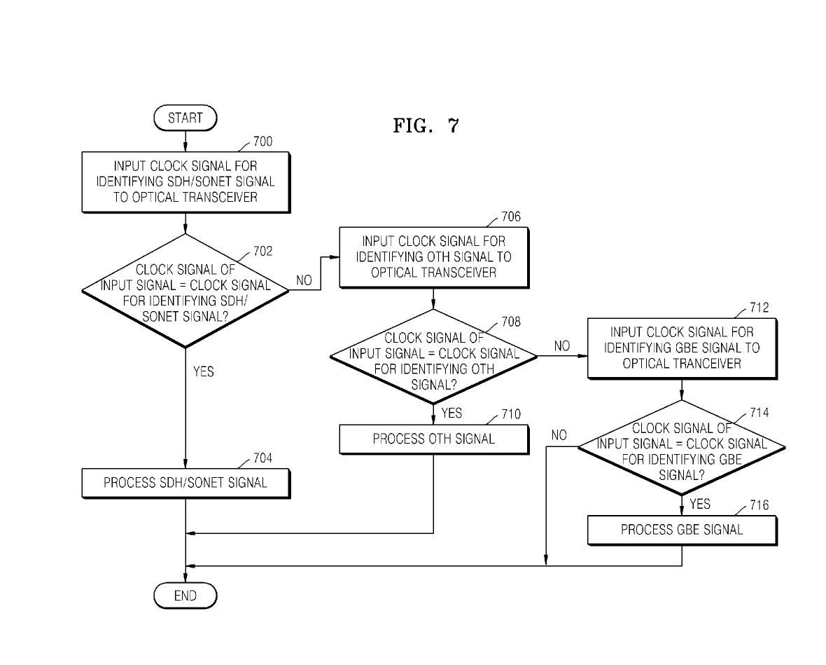

FIG. 7 is a flowchart for describing in detail a method of interfacing a multiprotocol signal according to an embodiment of the present invention.

First, when it is assumed that the optical transponder 200 of FIG. 2 connects to an SDH/SONET signal, the optical transceiver 220 is set to a mode for connecting to the SDH/SONET signal, and a crystal oscillator suitable to the SDH/SONET signal is selected by the first selector 310 and inputs a clock signal to the optical transceiver 220 in operation 700. When the clock signal comparator 222 of the optical transceiver 220 determines that the clock signal of the crystal oscillator and a clock signal of the input signal are identical in operation 702, the mode of a chip and board of the optical transponder 200 is changed so as to process an SDH/SONET protocol. In other words, in the case of the OTH framer 230, internal functions are all bypassed, and clock dividing ratios is set to be the same. A clock signal suitable to the SDH/SONET signal is selected and inputted to a related chip and optical transceiver. The SDH/SONET framer 240 processes the SDH/SONET signal in operation 704. However, if it is determined that the clock signal of the crystal oscillator and the clock signal of the input signal are not identical in operation 702, the input signal is not the SDH/SONET signal, and thus it is assumed that the optical transponder 200 connects to an OTH signal. Accordingly, the optical transceiver 220 is set to a mode for connecting to the OTH signal, and a crystal oscillator suitable to the OTH signal is selected and inputs a clock signal to the optical transceiver 220 in operation 706. When the clock signal comparator 222 determines that a clock signal of the selected crystal oscillator and the clock signal of the input signal are identical in operation 708, the mode of the chip and board of the optical transponder 200 is converted to process an OTH protocol. A clock signal suitable to the OTH signal is selected in inputted to a related chip and optical transceiver. The OTH framer 230 processes the OTH signal in operation 710. However, when it is determined that the clock signal of the selected crystal oscillator and the clock signal of the input signal are not identical in operation 708, the input signal is not the OTH signal, and thus it is determined that the optical transponder 200 is connected to a GbE signal. Accordingly, the optical transceiver 220 is set to a mode for connecting to the GbE signal, and a crystal oscillator suitable to the GbE signal is selected and inputs a clock signal to the optical transceiver 220 in operation 712. When the clock signal comparator 222 determines that a clock signal of the selected crystal oscillator and the clock signal of the input signal are identical in operation 712, the mode of the chip and board of the optical transponder 200 is changed to process a GbE protocol. A clock signal suitable to the GbE signal is selected and inputted to a related chip and optical transceiver in operation 716. The SDH/SONET framer 240 maps the GbE signal to the SDH/SONET signal.

The method of interfacing a multiprotocol signal described above interfaces any one of a 10 [Gb/s] multiprotocol signal, a 2.5 [Gb/s] multiprotocol signal, and a 40 [Gb/s] multiprotocol signal.

According to the optical transponder for interfacing a multiprotocol signal and the method of interfacing a multiprotocol signal of the present invention, various types of protocol signals can be received by using one transponder. Accordingly, different optical transponders for receiving different types of signals are not required to be separately installed.

In other words, for transponder manufacturers, the structure of an apparatus can be simplified and a flexible system can be organized according to the requirements of a network. Also, costs for manufacturing and managing various types of optical transponder PCBs can be reduced.

Also for communication enterprisers, when an optical transponder needs to be replaced since the requirement for signal connection is changed, the same optical transponder can be used instead of buying a new optical transponder. Accordingly, purchasing expenses can be reduced.

The method of interfacing a multiprotocol signal according to the present invention can be realized as a computer readable codes/instructions/programs. In other words, a computer readable recording medium having recorded thereon a program for executing a method of interfacing a multiprotocol signal, the method including detecting a type of an input signal, optical/electrical converting and multiplexing/demultiplexing the input signal, and processing an OTH signal, an SDH/SONET signal, or a GbE signal by generating a clock signal corresponding to the detected type is another feature of the present invention.

The embodiments of the present invention can be implemented in general-use digital computers that execute the codes/instructions/programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). Also, the embodiments of the present invention are realized as media including computer readable codes, which are distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical transponder that interfaces a multiprotocol signal, the optical transponder comprising:
an optical transceiver, which optical/electrical converts and multiplexes/demultiplexes an input signal;
a reception clock generator, which generates a clock on a reception path;
a transmission clock generator, which generates a clock on a transmission path;
an optical transport hierarchy (OTH) framer, which processes an OTH signal when the input signal is the OTH signal;
a synchronous digital hierarchy (SDH)/synchronous optical network (SONET) framer, which processes an SDH/SONET signal or a gigabit Ethernet (GbE) when the input signal is the SDH/SONET signal or the GbE signal; and
a controller which controls the optical transceiver, the reception clock generator, the transmission clock generator, the OTH framer, and the SDH/SONET framer according to the type of the input signal.

2. The optical transponder of claim 1, wherein the reception clock generator comprises:
a first through K-th crystal oscillators, which output corresponding clock signals according to each type of the input signal, where K is an integer bigger than 1;
a first selector, which selects any one of the first through K-th crystal oscillator according to the control of the controller;
a first frequency adjustment controller, which adjusts a frequency of a clock signal provided to the OTH framer and the SDH/SONET framer based on a clock signal reproduced by the input signal;
a first through K-th frequency adjustment oscillator, which outputs the clock signal whose frequency is adjusted according to the type of the input signal, according to the control of the first frequency adjustment controller; and
a second selector, which selects a frequency adjustment oscillator which outputs a clock signal corresponding to the input signal from among the first through K-th frequency adjustment oscillator, according to the control of the controller.

3. The optical transponder of claim 2, wherein the optical transceiver comprises:
an optical/electrical converter, which optical/electrical converts the input signal;
a multiplexer/demultiplexer, which multiplexes/demultiplexes the optical/electrical converted signal; and
a clock signal comparator, which compares whether the clock signal outputted from the crystal oscillator selected by the first selector is identical to the clock signal reproduced by the input signal,
wherein the clock signal comparator outputs the result of comparing the clock signals to the controller.

4. The optical transponder of claim 3, wherein the controller controls any one of the OTH framer and the SDH/SONET framer to operate according to the result of comparing the clock signals by the clock signal comparator.

5. The optical transponder of claim 4, wherein the controller controls the OTH framer to be bypassed when the input signal is the SDH/SONET signal or the GbE signal.

6. The optical transponder of claim 1, wherein the optical transceiver uses any one of an MSA transceiver, an XFP transceiver, and a SERDES transceiver.

7. The optical transponder of claim 1, wherein the SDH/SONET framer maps the GbE signal to the SDH/SONET signal when the input signal is the GbE signal.

8. The optical transponder of claim 1, wherein the transmission clock generator comprises:
a K+1 through 2K-th crystal oscillators, which output corresponding clock signals according to each type of the input signal, where K is an integer bigger than 1;
a third selector, which selects any one of the K+1 through 2K-th crystal oscillator according to the control of the controller;
a second frequency adjustment controller, which adjusts the frequency of a clock signal provided to the OTH framer and the optical transceiver based on a system clock;
a K+1 through 2K-th frequency adjustment oscillators, which outputs the clock signal whose frequency is adjusted according to the type of the input signal, according to the control of the second frequency adjustment controller; and
a fourth selector, which selects a frequency adjustment oscillator that outputs a clock signal corresponding to the input signal from among the K+1 through 2K-th frequency adjustment oscillator, according to the control of the controller.

9. The optical transponder of claim 1, interfacing any one multiprotocol signal from among a 10 [Gb/s] multiprotocol signal, a 2.5 [Gb/s] multiprotocol signal, and a 40 [Gb/s] multiprotocol signal.

10. A method of interfacing a multiprotocol signal, the method comprising:
detecting a type of an input signal;
optical/electrical converting and multiplexing/demultiplexing the input signal; and
processing an OTH signal, an SDH/SONET signal, or a GbE signal by generating a clock signal corresponding to the detected type.

11. The method of claim 10, wherein the detecting of the type comprises:
outputting any one clock signal from among clock signals corresponding to the types of the input signals;
comparing whether the outputted clock signal is identical to a clock signal reproduced by the input signal;
when the outputted clock signal is identical to the clock signal reproduced by the input signal, detecting a type of an input signal corresponding to the outputted clock signal; and
when the outputted clock signal is not identical to the clock signal reproduced by the input signal, repeating above processes of outputting any one clock signal from among clock signals corresponding to the types of the input signals and comparing whether the outputted clock signal is identical to a clock signal reproduced by the input signal.

12. The method of claim 10, wherein the processing of the OTH signal, the SDH/SONET signal, or the GbE signal bypasses the processing of the OTH signal, when the input signal is the SDH/SONET signal or the GbE signal.

13. The method of claim 10, wherein the processing of the OTH signal, the SDH/SONET signal, or the GbE signal maps the GbE signal to the SDH/SONET signal when the input signal is the GbE signal.

14. The method of claim 10, interfacing any one multiprotocol signal from among a 10 [Gb/s] multiprotocol signal, a 2.5 [Gb/s] multiprotocol signal, and a 40 [Gb/s] multiprotocol signal.

15. A computer readable recording medium having recorded thereon a program for executing a method of interfacing a multiprotocol signal, the method comprising:
detecting a type of an input signal;
optical/electrical converting and multiplexing/demultiplexing the input signal; and
processing an OTH signal, an SDH/SONET signal, or a GbE signal by generating a clock signal corresponding to the detected type.
